(19) United States
(12) Patent Application Publication
(10) Pub. No.: US 2003/0231997 A1
(43) Pub. Date: Dec. 18, 2003

(54) Titanium catalyst support substrate for selective catalytic reduction reactors

(76) Inventor: Norman Kettenbauer, Wadsworth, OH (US)

Correspondence Address: Kathryn W. Grant, Patent Department, The Babcock & Wilcox Company, 20 South Van Buren Avenue, Barberton, OH, 44203, US

(21) Appl. No.: 10/174,043

(22) Filed: Jun. 18, 2002

(51) Int. Cl. B01D 53/56

(52) U.S. Cl. 423/239.1; 502/350; 502/309

(57) ABSTRACT

A lightweight catalyst block for the selective reduction of nitrogen oxides from exhaust and waste gases in the presence of ammonia comprised of a catalytically active metal oxide deposited on catalyst support substrates of metallic titanium or alloys thereof. Suitable catalytically active oxides such TiO₂, V₂O₅, WO₃, MoO₃ and mixtures thereof can be deposited on the substrates via washcoating or applied as a paste or slurry. In one embodiment, the substrates are in the form of a lath having openings therethrough.

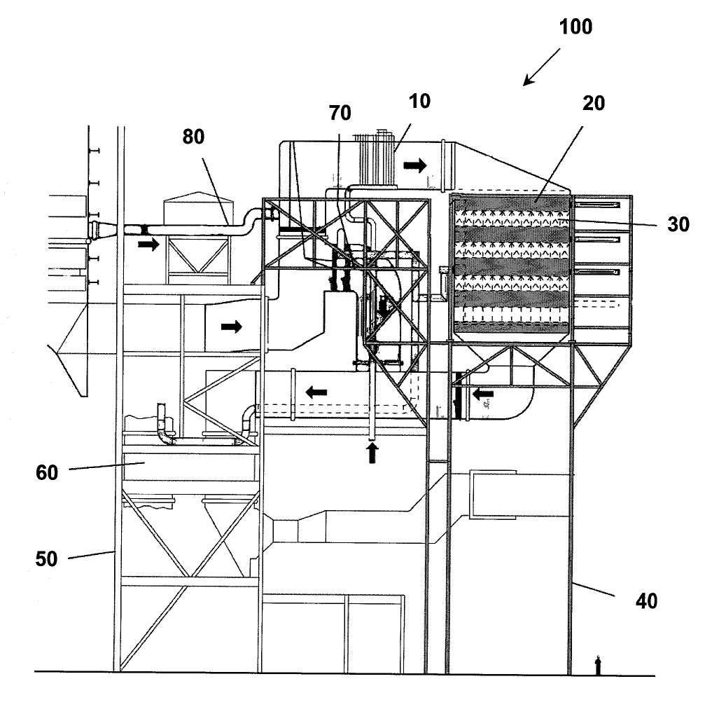

### FIELD AND BACKGROUND OF INVENTION

The invention relates generally to support substrates for catalysts, and more particularly to catalyst support substrates for selective catalytic reduction (SCR) reactors.

SCR systems are used to clean impurities from the exhaust gases of boiler and furnaces, and in particular, to reduce NOx emissions. Ammonia is injected into the boiler exhaust gas stream in the presence of a catalyst. Chemical reactions occur with the exhaust gas, which removes a large portion of NOx from the exhaust gas and converts it to water and elemental nitrogen. The SCR reactions take place within an optimal temperature range. Most can operate within a range of 450 to 840 deg. F (232 to 499 deg. C) but optimum performance occurs between 675 to 840 deg. F (357 to 499 deg. C). Outside of the recommended temperature range, many catalyst materials become less effective. Additional details of SCR systems for NOx removal are provided in Chapter 35 of Steam/ its generation and use, 40th Edition, Stultz and Kitto, Eds., Copyright ©1992, The Babcock & Wilcox Company, the text of which is hereby incorporated by reference as though fully set forth herein.

Most modem SCR systems use a block type catalyst which is manufactured in a parallel plate or honeycomb configuration. The size of the catalyst bed required to achieve effective NOx reduction at a utility power generation station is very, very large. For ease in handling and installation, the blocks are fabricated into large modules. For example, an SCR system built by The Babcock & Wilcox Company and retrofit to a 675 MW coal-fired power station included 31,664 cubic feet (897 cubic meters) of 0.25 in. (6 mm), plate-type catalyst supplied by Babcock-Hitachi. The catalyst was arranged in four stages or layers, with each stage containing a total of 144 blocks arrayed in a 12 by 12 pattern. Such large catalyst arrangements, with their related installation and system modification requirements, are expensive to build.

A sectional side view of the above installation is shown in the sole FIGURE. In this conventional configuration, SCR reactor 20 of the SCR system 100 includes several catalyst layers 30. Flue gas is discharged from SCR reactor 20 into an existing air heater 60. The SCR system 100 is designed with downflow of the flue gas, after upflow ductwork for the ammonia injection grid 10 and mixing. This results in a vertical reactor at a high elevation. As a consequence, construction represents a substantial total of the cost of an SCR system, particularly for retrofit systems. With as much 50% of the capital cost of an SCR retrofit involving construction of the equipment, constructability is thus an important design consideration for cost reduction. While existing structural steel 50 may be used, the sole FIGURE shows the large amount of new structural steel 40 that is needed to bear the weight of the SCR system, and the associated upstream and downstream ductwork. The foundation for the SCR system and structural steel must also be taken into consideration, and may require modification for retrofit installations.

Typical SCR de-nitration catalysts such as oxides of titanium (TiO₂), vanadium (V₂O₅), tungsten (WO₃) and molybdenum (MoO₃) are expensive. To reduce the quantity of the catalyst compounds used, they are therefore commonly coated on a metallic support substrate or on a ceramic honeycomb monolith. The plate-type SCR catalyst of the system shown in the sole FIGURE was supported via a stainless steel substrate. Although it is known to use titanium oxide (TiO₂) as an SCR de-nitration catalyst, in some applications titanium oxide has been used not as the catalyst, but is used instead as a ceramic monolith to support another different SCR de-nitration catalyst.

While metallic catalyst substrates and ceramic titanium oxide (TiO₂) catalyst substrates are known, none of the above references teach or suggest the very particular advantages offered by a catalyst substrate made of titanium metal or alloys thereof in an SCR system. In particular they fail to teach or suggest that the total cost of an SCR system can be reduced by using titanium, an expensive material, as the catalyst substrate.

### SUMMARY OF INVENTION

The present invention is drawn to an SCR catalyst block in which the catalyst support substrates are made of metallic titanium or alloys thereof. Titanium has a high strength-to-weight ratio thereby permitting the weight of the catalyst support to be reduced by approximately ½ compared to stainless steel while retaining equivalent strength.

Accordingly, one aspect/object of the invention is drawn to an SCR catalyst block which is light in weight.

Another aspect/object of the invention is drawn to an SCR catalyst block which is easier to fabricate, ship and assemble.

Yet another aspect/object of the invention is drawn to an SCR catalyst block which requires less structural steel to bear the weight of the system.

A still further aspect/object of the invention is drawn to an SCR catalyst block which provides a more rapid heat up from a cold condition, and a more rapid transient response to changes in flue gas temperature.

Accordingly, a catalyst block for the selective removal of nitrogen oxides from exhaust and waste gases in the presence of ammonia is provided comprised of a catalytically active metal oxide deposited on a plurality of substrates selected from titanium metal and alloys thereof.

In another embodiment, a method for catalytically removing nitrogen oxides from exhaust and waste gases in the presence of ammonia comprises providing a substrate selected from titanium metal and alloys thereof, and depositing a catalytically active metal oxide on the support substrate.

In yet another embodiment, a method for catalytically removing nitrogen oxides from exhaust and waste gases in the presence of ammonia, comprises providing a support substrate consisting essentially of titanium, and depositing a catalytically active metal oxide selected from the group consisting of TiO₂, V₂O₅, WO₃ and MoO₃ on the substrate.

The various features of novelty which characterize the invention are pointed out with particularity in the claims annexed to and forming part of this disclosure. For a better understanding of the present invention, and the operating advantages attained by its use, reference is made to the accompanying drawing and descriptive matter, forming a part of this disclosure, in which a preferred embodiment of the invention is illustrated.

### BRIEF DESCRIPTION OF THE DRAWINGS

In the accompanying drawing, forming a part of this specification, and in which reference numerals shown in the drawing designate like or corresponding parts throughout the same:

The sole FIGURE is a side sectional view of an SCR system where the present invention may be implemented.

### DESCRIPTION OF THE PREFERRED EMBODIMENTS

Depending on the grade, the density of stainless steel is roughly 8.03 gm/cm3. In contrast, the density of titanium is roughly 4.505 gm/cm3. By virtue of titanium's low density and high strength, changing the catalyst design to use an appropriate grade of titanium, e.g. Grade 11, a widely used titanium-palladium alloy comparable to Grade 1 titanium, in place of stainless steel would reduce SCR catalyst weight by about 44%.

While titanium is about twice as expensive as stainless steel, the weight of a titanium catalyst substrate can be reduced by approximately ½ compared to a substrate made of stainless steel. Since the titanium is purchased on a per unit weight basis, the cost of a titanium substrate would be roughly equivalent in cost to a stainless steel substrate, while offering several added advantages beyond those obtained with a stainless steel substrate.

The reduction in weight achieved with a titanium catalyst substrate significantly reduces the amount of structural steel needed to bear the weight of the SCR system, thereby lowering the purchased cost of the structural steel. In addition, the plates are easier to handle during manufacturing and installation, for example permitting lower capacity cranes to be used during installation or allowing more flexible scheduling during scheduled or unscheduled outages, thereby producing savings in both shipping and handling cost. Further, the entire SCR system will heat up and cool down more rapidly, providing a more rapid startup from a cold condition and a more rapid response to transient conditions. This is especially important since the temperature range where the catalytic NOx removal reactions are most efficient is relatively high and very narrow. As a still further advantage, if the catalyst were to crack or spall, this would expose the titanium substrate to oxygen in the flue gas. The titanium would oxidize to titanium oxide thereby catalyzing the selective reduction of NOx, albeit less effectively than the more active catalyst originally applied to the titanium substrate.

The SCR NOx removal catalyst, such as TiO₂, V₂O₅, WO₃ and MoO₃ and mixtures thereof, is applied to the titanium substrate via known techniques, for example via washcoating. Conventional washcoating generally produces a coating of a high surface area oxide, such as alumina, in combination with one or more catalysts. The washcoat may be applied in the same fashion one would apply paint to a surface, e.g. by spraying, direct application, or dipping the substrate into the washcoat material. Washcoating was originally developed by the automotive industry for catalytic NOx emission control. In automotive converters, the catalysts usually employed are noble metals like platinum, palladium, and rhodium. These noble metals, in the form of precursor chemicals, are coated upon a honeycomb support along with, or on top of, high surface area support metal oxides, such as alumina, ceria and titania, that are incorporated into the washcoat as oxides, precursor chemicals or mixtures. U.S. Pat. No. 4,762,567, issued to the W.R. Grace & Co., describes a method for applying a platinum catalyst to a metal substrate via an alumina washcoat, and is incorporated by reference as though fully set forth herein.

Known methods for applying a de-nitration catalyst to a stainless steel lath substrate, as either a paste or slurry, are described in U.S. Pat. Nos. 5,151,256 and 5,166,122, respectively. Both patents are issued to Babcock-Hitachi and are incorporated by reference as though fully set forth herein.

While specific embodiments and/or details of the invention have been shown and described above to illustrate the application of the principles of the invention, it is understood that this invention may be embodied as more fully described in the claims, or as otherwise known by those skilled in the art (including any and all equivalents), without departing from such principles. For example, in an alternative embodiment, a titanium alloy containing aluminum, such as the widely used Ti-6Al-4V alpha-beta alloy, could be employed as the catalyst substrate. Instead of washcoating, the aluminum in the alloy could be deliberately oxidized to create an alumina layer on the substrate thereby improving the adhesion of the catalyst to the support substrate.

I claim:

1. A catalyst block for the selective removal of nitrogen oxides from exhaust and waste gases in the presence of ammonia, comprising a catalytically active metal oxide deposited on a plurality of substrates selected from titanium metal and alloys thereof.

2. The catalyst block of claim 1, wherein the catalytically active metal oxide is selected from the group consisting of TiO₂, V₂O₅, WO₃, MoO₃ and mixtures thereof.

3. The catalyst block of claim 1, wherein the substrates are in the form of laths having openings therethrough.

4. The catalyst block of claim 1, wherein the substrates consist essentially of titanium.

5. A method for catalytically removing nitrogen oxides from exhaust and waste gases in the presence of ammonia, comprising providing a substrate selected from titanium metal and alloys thereof, and depositing a catalytically active metal oxide on the support substrate.

6. The method of claim 5, wherein the catalytically active metal oxide is selected from the group consisting of TiO₂, V₂O₅, WO₃, MoO₃ and mixtures thereof.

7. The method of claim 5, wherein the substrate is provided in the form of a lath having openings therethrough.

8. The method of claim 7, further comprising applying the catalyst as a paste to the support substrate.

9. The method of claim 5, further comprising applying the catalyst to the support substrate via washcoating.

10. The method of claim 5, wherein the substrate consists essentially of titanium.

11. A method for catalytically removing nitrogen oxides from exhaust and waste gases in the presence of ammonia, comprising:
providing a support substrate consisting essentially of titanium; and
depositing a catalytically active metal oxide selected from the group consisting of TiO₂, V₂O₅, WO₃, MoO₃ and mixtures thereof on the substrate.

12. The method of claim 11, wherein the substrate is in the form of a lath having openings therethrough.

13. The method of claim 12, further comprising applying the catalyst as a paste to the support substrate.

14. The method of claim 11, further comprising applying the catalyst to the support substrate via washcoating.
